(19) United States
(12) Patent Application Publication
(10) Pub. No.: US 2025/0186277 A1
(43) Pub. Date: Jun. 12, 2025

(54) Device for Relieving the Pressure that is Exerted on a Wheelchair User

(71) Applicant: AutoMax ApS, Vorbasse (DK)

(72) Inventor: Max BIRKELUND, Vorbasse (DK)

(21) Appl. No.: 19/054,333

(22) Filed: Feb. 14, 2025

Related U.S. Application Data
(63) Continuation of application No. PCT/DK2023/050201, filed on Aug. 15, 2023.

(30) Foreign Application Priority Data
Aug. 19, 2022 (DK) PA 2022 00769

(51) Int. Cl. A61G 5/10; A61G 5/12; A61G 15/00

(52) U.S. Cl. CPC A61G 5/1067; A61G 5/101; A61G 5/1013; A61G 5/122; A61G 15/007

(57) ABSTRACT

A device for relieving the pressure that is exerted on a wheelchair user when sitting in a wheelchair. The wheelchair having two driving wheels, a seat and a back support. The device comprising a motion prevention structure arranged and configured to prevent at least one of the driving wheels from moving forward and a moveably mounted support structure arranged to allow the wheelchair to be rotated about the wheel axis (X) of the wheelchair's driving wheels, thereby tilting the wheelchair backwards while supporting the back support and maintaining the driving wheels in a fixed horizontal and vertical position.

### CROSS-REFERENCE TO RELATED APPLICATIONS

This application is a continuation under 35 U.S.C. 111 of International Patent Application No. PCT/DK2023/050201, filed Aug. 15, 2023, which claims the benefit of and priority to Danish Application No. PA 2022 00769, filed Aug. 19, 2022, each of which is hereby incorporated by reference in its entirety.

### FIELD OF INVENTION

The present invention relates to a device for relieving the pressure that is exerted on a wheelchair user sitting in a wheelchair.

### BACKGROUND

People who are wheelchair dependent are limited in their mobility, sensory perception, and activity. The use of wheelchairs combined with these limitations often leads to increased temperature and moisture on the areas that are in contact with the wheelchair surface. Accordingly, wheelchair users have an increased risk for pressure injuries. A typical wheelchair pressure injury is localized damage to the skin and underlying soft tissue.

When persons spend a lot of time sitting in wheelchairs, they are more susceptible to developing a pressure injury, especially on an area of intense pressure like the buttocks. Wheelchair users can, however, also develop pressure sores on the backs of their thighs, their lower back and the folds of their knees.

It is recognized that many benefits accrue to wheelchair users when they are able to be adjusted periodically from an upright sitting position to a reclining position because the reclining position also eases pressure points and improves circulation and hence reduces swelling in the legs and feet and reduces the risk for developing a pressure injury.

However, wheelchair users heretofore have not been able to be adjusted to a reclining position without having a specially designed wheelchair. Therefore, wheelchair users heretofore have had to remain in an upright sitting position until transferred from the wheelchair to a bed or reclining chair, which requires physical effort, sometimes even the cooperation of at least two trained persons. Accordingly, most wheelchair users are left for long periods of time in the upright sitting position.

U.S. Pat. No. 6,478,529 B1 discloses a reclining platform wheelchair support on which a wheelchair can be mounted. The platform is pivotally mounted on a support frame for reclining the wheelchair and a seated patient in the wheelchair for various operations such as dental work, hair shampooing, or medical inspections of eyes, ears, nose and throat. This device is complex, expensive and requires an external power source to be operated.

U.S. Pat. No. 4,527,944 A discloses a device for tilting wheelchairs rearwardly to allow the occupant to attain a rearwardly inclined position. The device is, however, constructed in such a manner that the device is required to carry the entire weight of the wheelchair including the wheelchair user. Accordingly, the device must be constructed in order to accommodate large load requirements. Therefore, the device is rather complex, expensive and heavy.

U.S. Pat. No. 4,192,549 A discloses a cradle structure by which to enable the tilting of a wheelchair between upright and rearwardly tilted positions. This device is, however, complex, expensive and requires an external power source to be operated.

WO2017143454A1 discloses a tilting wheelchair comprising an upper section adapted to receive a user and a lower section. The wheelchair also comprises a pair of drive wheels pivotally mounted to the lower section on each side of the wheelchair. The drive wheels are pivotally mounted about a first rotation axis. The wheelchair also comprises a tilting mechanism being adapted to pivotally connect the upper section and the lower section about a second rotation axis. The wheelchair is, however, complex and expensive. Accordingly, it would be desirable to have an alternative that is simpler and less expensive.

Thus, there is a need for a device that in a simple, efficient and easy manner can relieve the pressure that is exerted on a wheelchair user sitting in a wheelchair.

### BRIEF DESCRIPTION

A device according to the present disclosure is a device for relieving the pressure that is exerted on a wheelchair user when sitting in a wheelchair having two driving wheels, a seat and a back support, wherein the device comprises:
a motion prevention structure arranged and configured to prevent at least one of the driving wheels from moving forward while maintaining the driving wheels in a fixed horizontal and vertical position; and
a moveably mounted support structure arranged to allow the wheelchair to be rotated about the wheel axis of the wheelchair's driving wheels and hereby tilting the wheelchair backwards while supporting the back support while maintaining the driving wheels in a fixed horizontal and vertical position.

The device can in an efficient and easy manner relieve the pressure that is exerted on a wheelchair user when sitting in a wheelchair. It is possible to provide a device that does not need to be powered by any external power source. In an embodiment, the device is mechanically driven and thus requires neither electrical power nor electrical control.

In an embodiment, the support structure is rotatably mounted to a frame of the device.

The device enables the wheelchair to be rotated about its own wheel axis (the wheel axis of the wheelchair's driving wheels) when the wheelchair is fixed to the frame.

In an embodiment, the device comprises a frame and a support structure that is connected to the frame and moveably arranged relative to the frame, wherein the support structure is configured to support the back support.

In an embodiment, the frame comprises two parallel side members connected by a connection member.

In an embodiment, each side member of the frame comprises two ground engaging legs.

In an embodiment, the device comprises one or more moveably arranged locking structures arranged and configured to engage with at least one of the driving wheels to prevent at least one of the driving wheels from moving forward. In this embodiment, the locking structures constitute the motion prevention structure.

In an embodiment, the one or more moveably arranged locking structures are rotatably attached to the frame.

In an embodiment, locking structures are rotatably attached to the frame, typically to a side member and/or a leg.

In an embodiment, locking structures comprise one or more rod-shaped elements arranged and configured to be brought into:
a) a first configuration, in which the locking structures are engaged with at least one driving wheel; and
b) a second configuration, in which the locking structures are brought out of engagement with the driving wheels.

In an embodiment, locking structures are arranged and configured to be reached by a user sitting in the wheelchair.

In an embodiment, the locking structures constitute a motion prevention structure that comprises a rod-shaped structure that is rotatably attached to the frame. In an embodiment, a stop member designed to be brought into contact with one of the wheels is provided in the distal end of the rod-shaped structure.

In an embodiment, a motion prevention structure is arranged and configured to prevent both driving wheels from moving forward while maintaining the driving wheels in a fixed horizontal and vertical position.

In an embodiment, the device comprises one or more arm rests in a position in which the wheelchair user can rest their arms on the one or more arm rests when sitting in a wheelchair.

In an embodiment, the device comprises a resilient member arranged in a manner in which its potential energy is increased when the back support is tilted backwards, wherein the resilient member is arranged and configured to assist the wheelchair user in tilting the back support forwards.

The resilient member may be a spring. In an embodiment, the resilient member is a spring arranged in a position in which its longitudinal axis is horizontal. It is important to emphasize that the longitudinal axis of the resilient member does not need to be horizontal. Accordingly, the longitudinal axis of the resilient member may be angled with a non-zero angle relative to horizontal. In an embodiment, the longitudinal axis of the resilient member is angled 5-85 degrees relative to horizontal.

In an embodiment, the device comprises a control member that is arranged and configured to provide a force large enough to maintain the back support in a position.

In an embodiment, the control member is a pneumatic cylinder.

In an embodiment, the motion prevention structure is a moveably arranged locking structure arranged and configured to engage with a driving wheel of the wheelchair to prevent the driving wheel from moving forward.

In an embodiment, the motion prevention structure is a moveably arranged locking structure arranged and configured to engage with a push rim of a driving wheel of the wheelchair to prevent the driving wheel from moving forward.

In an embodiment, the device comprises a right locking structure arranged and configured to engage with the right driving wheel of the wheelchair.

In an embodiment, the device comprises a left locking structure arranged and configured to engage with the push rim of the left driving wheel of the wheelchair.

In an embodiment, the device comprises a right locking structure arranged and configured to engage with the push rim of the right driving wheel of the wheelchair.

In an embodiment, the device comprises a left locking structure arranged and configured to engage with the left driving wheel of the wheelchair.

In an embodiment, the device comprises a right locking structure arranged and configured to engage with a spoke of the right driving wheel of the wheelchair and a left locking structure arranged and configured to engage with a spoke of the left driving wheel of the wheelchair.

A method according to the present disclosure is a method for rotating a wheelchair having two driving wheels, a seat and a back support, wherein the method comprises the step of changing the orientation of the back support relative to vertical by rotating a support structure of a device while the support structure supports the back support, wherein the method comprises the following steps:
preventing at least one of the driving wheels from moving forward, while maintaining the driving wheels in a fixed horizontal and vertical position;
rotating the support structure about the wheel axis of the wheelchair's driving wheels and hereby tilting the back support backwards while supporting the support structure; and
maintaining the back support in this orientation for a time period.

Hereby, it is possible to provide a method that, in an efficient and easy manner, can rotate a wheelchair. Accordingly, one may have access to parts of the wheelchair that are not accessible when the wheelchair is standing on the ground or a floor.

In an embodiment, the method comprises application of a device according to the present disclosure.

The wheelchair typically has two driving wheels, a seat and a back support.

By changing the orientation of the back support relative to vertical, it is possible to relieve the pressure that is exerted on a wheelchair user if a wheelchair user is sitting in the wheelchair.

By preventing at least one of the driving wheels from moving forward, while maintaining the driving wheels in a fixed horizontal and vertical position it is possible to stay seated in the wheelchair while rotating the back support about the wheel axis of the wheelchair.

The method enables the wheelchair to be rotated about its own wheel axis (the wheel axis of the wheelchair's driving wheels) when the wheelchair is fixed to the frame.

In an embodiment, the method comprises the following step:
preventing both driving wheels from moving forward, while maintaining the driving wheels in a fixed horizontal and vertical position.

In an embodiment, the driving wheels are kept in engagement with the ground (the surface, e.g. a floor, on which the wheelchair is placed).

By maintaining the back support in a tilted orientation for a time period it is possible to relieve the pressure that is exerted on the wheelchair user for the time period, if a wheelchair user is sitting in the wheelchair. Accordingly, it is possible to relieve the pressure efficiently and make using a wheelchair more comfortable.

By the term “preventing the driving wheels from moving forward” is to be understood any action that the prevents at least one of the driving wheels from moving forward.

In an embodiment, the action prevents both driving wheels from moving forward.

In an embodiment, a method comprises the step of applying a moveably arranged support structure to support the back support. Hereby, the back support of the wheelchair, and thus the wheelchair user, can be supported by the support structure(s).

In an embodiment, a method comprises the step of applying one or more moveably arranged locking structures to engage with at least one of the driving wheels to prevent at least one of the driving wheels from moving forward.

Hereby, it is possible to prevent at least one of the driving wheels from moving forward in a simple, practical and reliable manner.

In an embodiment, a method comprises the step of providing one or more arm rests in a position in which the wheelchair user can rest their arms on the one or more arm rests when sitting in a wheelchair.

Hereby, the wheelchair user is offered a more comfortable experience.

In an embodiment, a method comprises the steps of:
a) applying a resilient member arranged in a manner in which its potential energy is increased when the back support is tilted backwards; and
b) applying the resilient member to assist the wheelchair user in tilting the back support forwards.

Hereby, the wheelchair user will experience a more comfortable rotation.

In an embodiment, the resilient member is a spring. In an embodiment, the resilient member is a spring arranged in a position in which its longitudinal axis is horizontal. It is important to emphasize that the longitudinal axis of the resilient member does not need to be horizontal. Accordingly, the longitudinal axis of the resilient member may be angled with a non-zero angle relative to horizontal. In an embodiment, the longitudinal axis of the resilient member is angled 5-85 degrees relative to horizontal.

In an embodiment, a method comprises the step of applying a control member to provide a force large enough to maintain the back support in a position. Hereby, it is possible to provide a more user-friendly solution.

In an embodiment, the control member is a pneumatic cylinder.

In an embodiment, the control member is arranged and configured to steplessly position the back support. Hereby, a high degree of freedom regarding the angular position of the back support can be achieved.

### BRIEF DESCRIPTION OF THE DRAWINGS

The devices and methods will become more fully understood from the detailed description given herein below. The accompanying drawings are given by way of illustration only, and thus, they are not limitative. In the accompanying drawings:

FIG. 1A shows a schematic side view of a device according to an embodiment in a first configuration;

FIG. 1B shows the device shown in FIG. 1A in a second configuration;

FIG. 2 shows a device according to an embodiment in a configuration in which a wheelchair has been placed in the device;

FIG. 3 shows another view of the device shown in FIG. 2;

FIG. 4 shows another view of the device shown in FIG. 2 and FIG. 3;

FIG. 5 shows a front view of a device according to an embodiment; and

FIG. 6 shows another device according to an embodiment in a configuration in which a wheelchair has been placed in the device.

### DETAILED DESCRIPTION

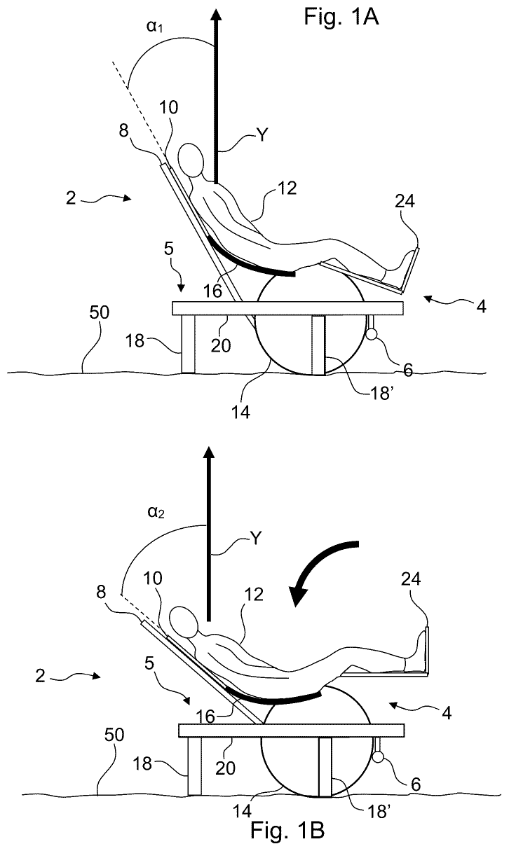

Referring now in detail to the drawings for the purpose of illustrating embodiments of the present devices and methods, a device 2 is illustrated in FIG. 1A.

FIG. 1A illustrates a schematic side view of a device 2 according to an embodiment in a first configuration. FIG. 1B illustrates the device shown in FIG. 1A in a second configuration.

The device 2 comprises a frame 5 comprising two parallel side members 20 (of which only one is visible). The side members 20 are provided with ground engaging legs 18, 18′.

The device 2 is intended for relieving the pressure that is exerted on a wheelchair user 12 when sitting in a wheelchair 4 having two driving wheels 14, a seat 16 and a back support 10.

The device 2 comprises a motion prevention structure 6 arranged and configured to prevent the driving wheels 14 from moving forward while maintaining the driving wheels 14 in a fixed horizontal and vertical position. The motion prevention structure 6 comprises a rod-shaped structure that is rotatably attached to the frame 5. A stop member designed to be brought into contact with one of the wheels 14 is provided at the distal end of the rod-shaped structure.

The motion prevention structure 6 is arranged in the front end of the device 2. The stop member is arranged and configured to be brought into contact with a front end of one of the wheels 14.

It can be seen that the driving wheels 14 are placed on the floor or ground 50 while being maintained in the same horizontal and vertical position in both FIG. 1A and in FIG. 1B. This means that the driving wheels 14 are maintained in a fixed horizontal and vertical position when the wheelchair 4 is rotated from the first configuration (shown in FIG. 1A), in which the angle α₁ between the longitudinal axis of the back support 10 and vertical Y to the second configuration (shown in FIG. 1B), in which the angle α₂ between the longitudinal axis of the back support 10 and vertical Y is increased.

The wheelchair 4 comprises a footrest 24 arranged and configured to support the feet of the user 12.

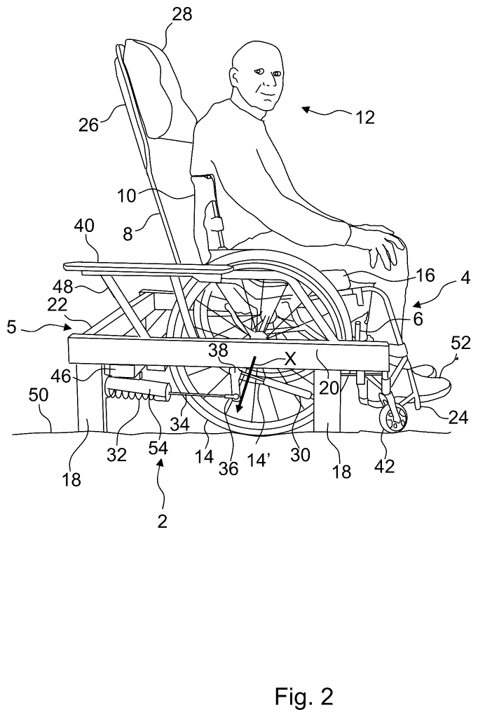

The device 2 comprises a moveably mounted support structure 8 arranged to allow the wheelchair 4 to be rotated about a horizontal axis (see FIG. 2) hereby tilting the wheelchair 4 backwards while supporting the back support 10 while maintaining the driving wheels 14, 14′ in a fixed horizontal and vertical position.

The device 2 comprises an open end through which the wheelchair 4 can enter the device 2. In FIG. 1A and FIG. 1B the open end is located in the end in which the footrest is positioned. Accordingly, the wheelchair user 12 has reversed the wheelchair 4 through the open end to enter the position indicated in FIG. 1A and FIG. 1B.

FIG. 2 illustrates a device 2 according to an embodiment in a configuration in which a wheelchair 4 has been placed in the device 2. The device 2 comprises a frame 5 that is placed on the floor or ground 50. The frame comprises two parallel side members 20 connected by a connection member 22 and a connection structure 46.

The frame 5 comprises legs 18, 18′ connecting the side members 20 to the floor or ground 50.

The device 2 comprises two arm rests 40 each connected to side frame 20 by a load bearing structure 48.

The device 2 comprises a support structure 8 configured to support the back support 10 of the wheelchair 4. The support structure 8 is attached to the support element 26 that is rotatably attached to the frame 5.

The wheelchair user 12 is sitting on the seat 16 of the wheelchair 4 and rests on the back support 10 of the wheelchair 4. The wheelchair user 12 rests on a footrest 24 of the wheelchair 4.

The device 2 comprises a moveably arranged locking structure 6 arranged and configured to engage with the right driving wheel 14 to prevent this driving wheel 14 from moving forward. The device 2 comprises both a right driving wheel 14 and a left driving wheel 14′.

The device 2 comprises a resilient member 32 arranged in a manner in which its potential energy is increased when the back support 10 is tilted backwards. The resilient member 32 is formed as a spring placed in a semi-cylindrical sleeve 54. The spring 32 is arranged and configured to assist the wheelchair user 12 to tilt the back support 10 forwards.

The spring 32 is connected to a joint member 38 by a connection piece 34 that is attached to an attachment member 36. The connection piece 34 may be a metal rod or metal tube.

The device 2 comprises a control member 30 that is arranged and configured to provide a force large enough to maintain the back support 10 in a position. The control member 30 is a pneumatic cylinder. In an embodiment, the control member is a pneumatic cylinder arranged and configured to steplessly positioning the back support. Hereby, a high degree of freedom regarding the angular position of the back support 10 can be achieved.

The wheelchair 4 comprises steerable front wheels 42.

The moveably mounted support structure 8 is arranged and configured to enable the wheelchair 4 to be rotated about the wheel axis X of the wheelchair's driving wheels 14 and hereby tilt the wheelchair 4 backwards while supporting the back support 10 while maintaining the driving wheels 14 in a fixed horizontal and vertical position.

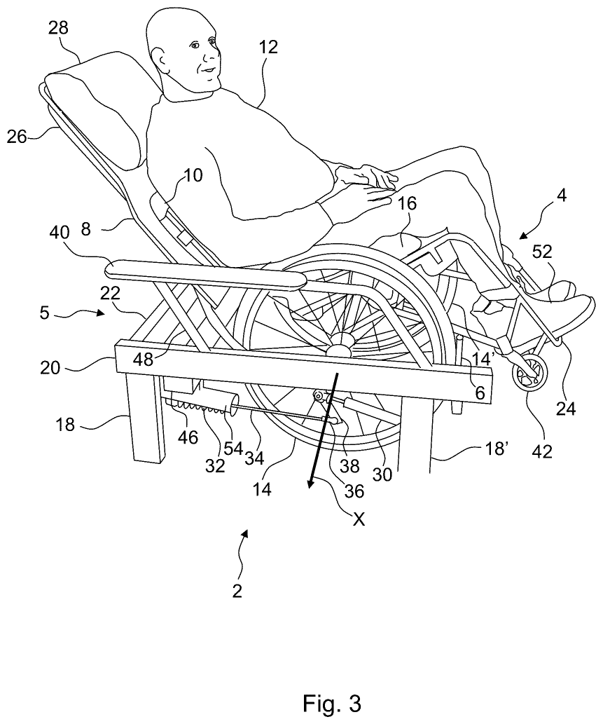

FIG. 3 illustrates another view of the device 2 shown in FIG. 2. The back support 10 of the wheelchair 4, however, has been rotated backwards about a horizontal axis of rotation because the support structure 8 of the device 2 has been rotated backwards about said horizontal axis. Accordingly, the wheelchair user is positioned in a more inclined position than in FIG. 2. The device 2 is configured to facilitate the wheelchair 4 being rotated about the wheel axis X of the wheelchair's driving wheels 14 14′ and hereby tilt the wheelchair 4 while maintaining the driving wheels 14, 14′ in a fixed horizontal and vertical position.

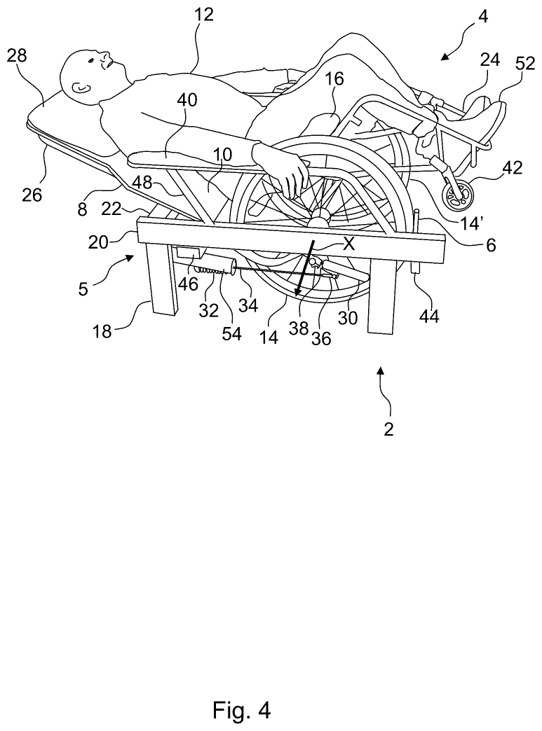

FIG. 4 illustrates another view of the device 2 shown in FIG. 2 and FIG. 3. The back support 10 of the wheelchair 4, however, has been rotated even further backwards about a horizontal axis of rotation due to a corresponding rotation of the support structure 8. Accordingly, the wheelchair user is positioned in an even more inclined position than in FIG. 3. Therefore, the pressure exerted on a wheelchair user's bottom and legs is reduced while the pressure exerted on the back of the wheelchair user 12 is increased. It can be seen that the wheelchair 4 has been rotated about the wheel axis X of the wheelchair's driving wheels 14 14′ while maintaining the driving wheels 14, 14′ in a fixed horizontal and vertical position.

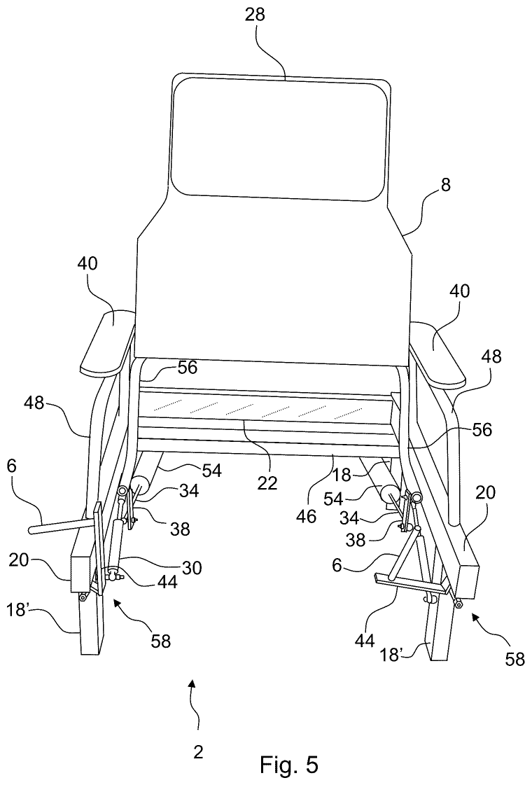

FIG. 5 illustrates a front view of a device 2 according to an embodiment. The device 2 corresponds to the one shown in and explained with reference to FIG. 2, FIG. 3 and FIG. 4. The device 2 comprises a frame. The frame comprises two parallel side members connected by a connection member.

In an embodiment, each side member of the frame comprises two ground engaging legs 18, 18′.

The device 2 comprises an open end allowing a wheelchair to enter the receiving space defined by the frame 5.

The frame may be made of any suitable material. In an embodiment, at least some of the side members 20, legs 18, 18′, connection member 22, connection structure 46 and the load bearing structures 48 are made of metal.

In an embodiment, the side members 20, legs 18, 18′, connection member 22, connection structure 46 and the load bearing structures 48 are made of metal.

The side members 20, legs 18, 18′, connection member 22, connection structure 46 and the load bearing structures 48 can be made of other materials such as plastic, wood or a composite material.

In an embodiment, at least some of the side members 20, legs 18, 18′, connection member 22 and connection structure 46 are made of wood.

In an embodiment, the side members 20, legs 18, 18′, connection member 22 and connection structure 46 are made of wood. In an embodiment, and the load bearing structures 48 are made of wood.

The device 2 comprises two transmission elements 56 that are connected to the support element (see FIG. 2, FIG. 3 and FIG. 4).

In each side of the frame of the device 2 a connection piece 34 constitutes a rigid mechanical connection between the resilient member extending inside the sleeve 54 and the joint member 38. The joint member 38 is attached to the distal end of the transmission elements 56. Hereby, the resilient member (spring) can store potential energy generated when the support structure 8 is tilted backwards and the transmission elements 56 are moved accordingly. Therefore, the resilient member (spring) can assist the wheelchair user in tilting the support structure 8 forwards.

In each side of the frame a control member 30 formed as a pneumatic cylinder is provided. Each pneumatic cylinder is connected to the distal end of a corresponding transmission element 56 and a front leg 18′. Accordingly, the pneumatic cylinder extends between the distal end of a corresponding transmission element 56 and a front leg 18′.

The pneumatic cylinder may alternatively extend between the distal end of a corresponding transmission element 56 and the corresponding side member 20.

Each pneumatic cylinder can be activated and controlled by a control structure (not shown) connected to the pneumatic cylinder.

The device 2 comprises a locking structure 6 formed as a rod. The rod-shaped locking structure 6 is attached to a mounting plate 44 that is rotatably attached to the side member 20 by a hinge 58.

In an embodiment, the hinge 58 is moveably attached to the side frame 20. Hereby, it is possible to adjust the position of the hinge 58 to wheelchairs of different sizes.

On one side, the mounting plate 44 extends basically upright and the locking structure 6 extends basically horizontally.

On the opposite side, the mounting plate 44 extends basically horizontally and the locking structure 6 extends almost upright. In this configuration, the locking structure 6 is arranged and configured to be brought into engagement with a front part of the left driving wheel of a wheelchair that has entered the device 2 and hereby prevent said driving wheel from moving forward. Accordingly, the locking structure 6 is configured to maintaining the driving wheel in a fixed horizontal and vertical position.

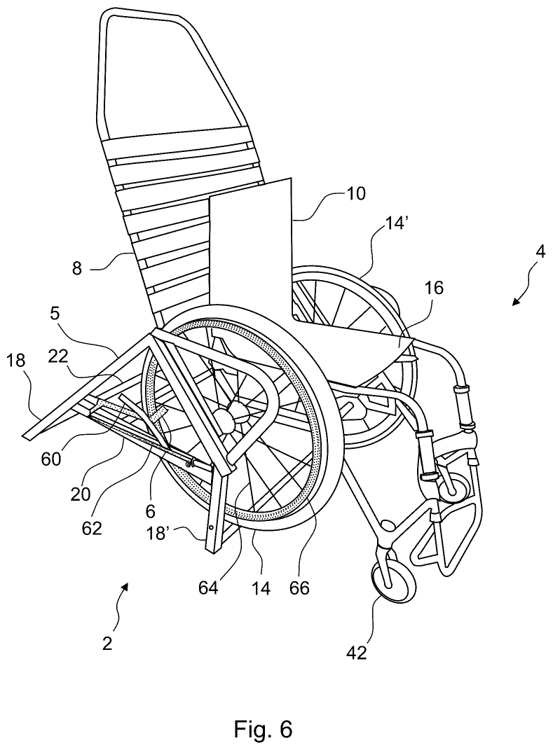

FIG. 6 illustrates a device 2 according to an embodiment in a configuration, in which a wheelchair 4 has been placed in the device 2. The device 2 comprises a frame 5 that is placed on the floor or ground. The frame comprises two parallel side members 20. Each side member 20 extends between a front leg 18 and a rear leg 18′. A connection member 22 connects the rear legs 18′.

The device 2 comprises a support structure 8 configured to support the back support 10 of the wheelchair 4. The wheelchair 4 comprises steerable front wheels 42. The support structure 8 is rotatably attached to the frame 5.

The device 2 comprises a moveably arranged locking structure 6 arranged and configured to engage with the push rim 66 of the driving wheel 14, 14′ of the wheelchair 4 to prevent the driving wheel 14, 14′ from moving forward. The device 2 may comprise:
1) a right locking structure 6 arranged and configured to engage with the push rim 66 of the right driving wheel 14 of the wheelchair 4; and/or
2) a left locking structure 6 arranged and configured to engage with the push rim 66 of the left driving wheel 14′ of the wheelchair 4.

The locking structure 6 is part of a basically L-shaped element that is rotatably mounted to the frame 5. It is important to emphasize that the locking structure 6 can have another geometry.

A rod member 62 is connected to the locking structure 6 and a handle 60. The handle 60 is arranged and configured to bring the locking structure 6:
a) into engagement with the push rim 66; and
b) out of engagement with the part of the push rim 66.

Accordingly, the handle 60 is arranged and designed to move the locking structure 6 into engagement with and out of engagement with the push rim 66.

The moveably mounted support structure 8 is arranged and configured to enable the wheelchair 4 to be rotated about the wheel axis of the wheelchair's driving wheels 14 and hereby tilt the wheelchair 4 backwards while supporting the back support 10 while maintaining the driving wheels 14 in a fixed horizontal and vertical position.

### LIST OF REFERENCE NUMERALS

2 Device
4 Wheelchair
5 Frame
6 Locking structure
8 Support structure
10 Back support
12 Wheelchair user
14 Driving wheel
16 Seat
18, 18′ Leg
20 Side member
22 Connection member
24 Foot rest
26 Support element
28 Cushion
30 Control member
32 Resilient member
34 Connection piece
36 Attachment member
38 Joint member
40 Arm rest
42 Steerable wheel
44 Plate or rod
46 Connection structure
48 Load bearing structure
50 Floor or ground
52 Foot
54 Sleeve
56 Transmission element
58 Hinge
60 Handle
62 Rod member
64 Spoke
66 Push rim
α₁, α₂ Angle
Y Vertical
X Wheel axis of the wheelchair's driving wheels

What is claimed is:

1. A device for relieving pressure exerted on a wheelchair user sitting in a wheelchair that has two driving wheels, a seat and a back support, the device comprising:
a motion prevention structure arranged and configured to prevent at least one of the two driving wheels from moving forward while maintaining the two driving wheels in a fixed horizontal and vertical position; and
a moveably mounted support structure arranged to allow the wheelchair to be rotated about a wheel axis of the two driving wheels, thereby tilting the wheelchair backwards while supporting the back support and maintaining the two driving wheels in the fixed horizontal and vertical position.

2. The device according to claim 1, further comprising a frame, wherein the support structure is connected to the frame, moveably arranged relative to the frame, and configured to support the back support.

3. The device according to claim 2, further comprising one or more moveably arranged locking structures arranged and configured to engage with at least one of the two driving wheels to prevent at least one of the two driving wheels from moving forward.

4. The device according to claim 1, further comprising one or more moveably arranged locking structures arranged and configured to engage with at least one of the two driving wheels to prevent at least one of the two driving wheels from moving forward.

5. The device according to claim 1, further comprising one or more arm rests in a position in which the wheelchair user can rest their arms on the one or more arm rests when sitting in the wheelchair.

6. The device according to claim 1, further comprising a resilient member arranged in a manner in which its potential energy is increased when the back support is tilted backwards, wherein the resilient member is arranged and configured to assist the wheelchair user in tilting the back support forwards.

7. The device according to claim 1, further comprising a control member that is arranged and configured to provide a force large enough to maintain the back support in a position.

8. The device according to claim 1, wherein the motion prevention structure is a moveably arranged locking structure arranged and configured to engage with a spoke of at least one of the two driving wheels of the wheelchair to prevent the driving wheel(s) from moving forward.

9. A method for rotating a wheelchair having two driving wheels, a seat and a back support by changing an orientation of the back support relative to vertical by rotating a support structure of a device while the support structure supports the back support, the method comprising the following steps:
preventing at least one of the two driving wheels from moving forward while maintaining the two driving wheels in a fixed horizontal and vertical position;
rotating the support structure about the wheel axis of the two driving wheels, thereby tilting the back support backwards while supporting the back support with the support structure; and
maintaining the back support in the tilted orientation for a time period.

10. The method according to claim 9, wherein the support structure is moveably arranged.

11. The method according to claim 9, further comprising applying one or more moveably arranged locking structures to engage with at least one of the two driving wheels to prevent at least one of the two driving wheels from moving forward.

12. The method according to claim 9, further comprising providing one or more arm rests in a position in which the wheelchair user can rest their arms on the one or more arm rests when sitting in the wheelchair.

13. The method according to claim 9, further comprising:
applying a resilient member arranged in a manner in which its potential energy is increased when the back support is tilted backwards; and
applying the resilient member to assist the wheelchair user in tilting the back support forwards.

14. The method according to claim 9, further comprising applying a control member to provide a force large enough to maintain the back support in a position.
